(19) United States
(12) Patent Application Publication
(10) Pub. No.: US 2026/0059324 A1
(43) Pub. Date: Feb. 26, 2026

(54) APPARATUS AND METHOD FOR IDENTIFYING LOCATION OF UNAUTHORIZED DEVICE

(71) Applicant: Hitachi, Ltd., Tokyo (JP)

(72) Inventors: Keigo KOBAYASHI, Tokyo (JP); Takuma NISHIMURA, Tokyo (JP); Tsutomu UCHIDA, Tokyo (JP); Ryuutarou TOMOZAWA, Tokyo (JP)

(21) Appl. No.: 19/077,418

(22) Filed: Mar. 12, 2025

(30) Foreign Application Priority Data
Aug. 23, 2024 (JP) 2024-141666

(51) Int. Cl. H04W 12/63

(52) U.S. Cl. CPC H04W 12/63

(57) ABSTRACT

The efficient identification of the connection location of an unauthorized device is enabled in a large-scale network. Upon receiving a notification of a physical address sent from an unauthorized device connected to a network, a first connection port corresponding to the physical address of the unauthorized device is acquired. From a first network device, a second connection port corresponding to a physical address of a network device connected to the first network device is acquired. First processing is executed to identify the network devices having the second connection port number that is the same as the first connection port number. Second processing is executed to acquire, from a second network device identified by the first processing, a third connection port corresponding to a physical address of network devices connected to the second network device. A connection location of the unauthorized device is identified by repeating the first and second processing.

### CLAIM OF PRIORITY

The present application claims priority from Japanese Patent Application JP 2024-141666 filed on Aug. 23, 2024, the content of which is hereby incorporated by reference into this application.

### TECHNICAL FIELD

The present invention relates to an apparatus and a method for identifying a connection location of an unauthorized device connected to devices constituting a network.

### BACKGROUND ART

The devices (for example, network devices such as switching hubs, L2 switches, and L3 switches) that constitute a network hold information relating to devices and the like (device and equipment such as personal computers and printers) connected to the network as a management function. Examples of such information include the Forwarding DataBase (FDB), which is information indicating the correspondence between the physical addresses (Media Access Control (MAC) addresses) of devices and other equipment connected to a network device and the ports (connection port numbers) of the network device to which the devices and other equipment are connected.

The FDB held by the network device can generally be requested and acquired using Simple Network Management Protocol (SNMP). The SNMP is a protocol for managing and monitoring devices and equipment in a network. To use the SNMP, software called an SNMP manager is installed in advance on a management device that is used by an administrator, while software called SNMP agent is installed on devices and equipment in the network (in many cases, network devices and equipment have embedded SNMP agent software). The SNMP manager in the management device requests information from the SNMP agents in the network devices and the like, and monitors the operating status. The SNMP agents notify the SNMP manager of the information requested by the SNMP manager and the status of the network devices and the like. In this manner, the SNMP manager and the SNMP agents exchange information, thereby enabling the management device to manage and monitor the network devices and the like.

Since a plurality of devices, such as other network devices or equipment, are connected to a network device, as described above, the MAC addresses of the plurality of connected devices and their corresponding connection port numbers are registered in the FDB that indicates the correspondence between the MAC addresses and connection port numbers of the devices and other equipment connected to the network device. To acquire all of the information in such FDB, the SNMP manager sends a request (command) called GetNext Request, which is defined in the SNMP, to the SNMP agent. GetNext Request is a command that requests the next piece of the management information (FDB in this example) specified to the SNMP agent. For example, the SNMP manager first sends, to the SNMP agent, a GetNext Request requesting the FDB. In response, the SNMP agent returns the first piece of information in the FDB by sending a response (command) called Get Response, which is defined in the SNMP, to the SNMP manager. Similarly, the SNMP manager sends a GetNext Request to request the next piece of information in the FDB, and the SNMP agent returns the second piece of information in the FDB. By repeating this sequence the number of times equal to the number of pieces of information registered in the FDB, the SNMP manager acquires all information in the FDB from the SNMP agent.

Note that when the SNMP manager acquires specific information in the FDB from the SNMP agent, the SNMP manager sends a request (command) called Get Request, which is defined in the SNMP, to the SNMP agent. Get Request is a command that requests specific information from the management information (FDB in this example) specified to the SNMP agent. For example, the SNMP manager sends a Get Request requesting the connection port number information corresponding to a specific MAC address, and the SNMP agent returns the information corresponding to the specified MAC address using a Get Response. With the use of the FDB, the management device used by the administrator can identify the connection location of devices connected to the network.

For example, PTL 1 discloses an apparatus and method for identifying the connection location of an unauthorized device, whereby it is possible to identify the connection port of the device illegally connected to a network device by collecting an FDB and the like from each network device in a network.

### CITATION LIST

### Patent Literature

PTL 1: Japanese Unexamined Patent Application Publication No. 2006-148255

### SUMMARY OF INVENTION

### Technical Problem

In a large-scale network (network with 1,000 or more connected devices), when a device that has not been approved for connection by an administrator (hereinafter referred to as an unauthorized device) is connected to the network, in order to identify the connection location of the unauthorized device, it is sufficient that the SNMP manager in the management device requests and acquires all the information in the FDB from the SNMP agent in each network device, and then analyzes and processes the content of the information, as in the conventional technology described in the above PTL 1. However, in a large-scale network such as the above, since a number of network devices and equipment are connected to each network device, a number of pieces of information (as many as the number of the connected devices and pieces of equipment) are also registered in the FDB. If the SNMP manager tries to request and acquire all such FDB information from each SNMP agent as described above, it is necessary to repeat the above sequence comprised of a request by GetNext Request and a response by Get Response for each piece of information registered in the FDB, which takes a great deal of time. Each piece of information registered in the FDB is deleted if no data is sent or received from the devices and other equipment with the MAC address in the information before the elapse of a predetermined period of time called aging time. As a result, the FDB is always kept up to date, but if it takes a long time to obtain the FDB from each network device, the information that is originally desired to be obtained (connection information of the unauthorized device described above) may be deleted from each FDB and may not be acquired.

In addition, as described above, in a large-scale network, a number of pieces of information are registered in each FDB, resulting in a large amount of data in each individual FDB. Therefore, in order to acquire a plurality of FDBs with such large amounts of data, the management device needs to be equipped with memory or storage devices with large storage capacities, and also needs to have higher processing power to analyze and process the plurality of FDBs with large amounts of data.

Meanwhile, when a simple apparatus with lower processing power and smaller memory capacity than a typical personal computer is used as a management device to try to identify the connection location of an unauthorized device in a large-scale network, it is difficult for such a device to acquire, analyze, and process all FDB information from each network device due to the limited memory capacity. In addition, even if all the information in each FDB is acquired by such a device, as described above, there would be a problem in that it would take a long time to complete the acquisition of all the FDBs.

The present invention has been made in view of such problems, and aims to enable even a simple apparatus with low processing power and small memory capacity to efficiently identify the connection location of an unauthorized device in a large-scale network.

### Solution to Problem

The present invention contains a plurality of means for addressing at least some of the above problems, and examples thereof are as follows. That is, a location identification apparatus for an unauthorized device connected to a network that is configured by a plurality of network devices being connected in multiple stages, the location identification apparatus including a location identification processing unit. Upon receiving a notification of a physical address sent from the unauthorized device, the location identification processing unit acquires, from each of the network devices, number of a first connection port corresponding to the physical address of the unauthorized device among one or more connection ports of each of the network devices, acquires, from a first network device that is one of the plurality of network devices, number of a second connection port corresponding to a physical address of each of one or more other network devices connected to the first network device, executes first processing for identifying the one or more other network devices having the second connection port number that is the same as the first connection port number, executes second processing for acquiring, from a second network device that is one of the one or more other network devices identified by the first processing, number of a third connection port corresponding to a physical address of each of one or more other network devices connected to the second network device, and identifies a connection location of the unauthorized device by repeating the first processing and the second processing.

### Advantageous Effects of Invention

According to the present invention, even in large-scale networks, a simple apparatus with low processing power and small memory capacity is capable of efficiently identifying the connection location of an unauthorized device in less time.

Objects, configurations, and effects other than the above will be apparent from the description of the following embodiments.

### BRIEF DESCRIPTION OF DRAWINGS

FIG. 1 is a block diagram illustrating an example of the overall configuration of a network according to a first embodiment.

FIG. 2 is a block diagram illustrating an example of the configuration of a location identification apparatus 10 according to the first embodiment.

FIG. 3 illustrates an example of the procedure of processing for identifying the connection location of an unauthorized device connected to the network according to the first embodiment.

FIG. 4A illustrates an example of an FDB held by each SW according to the first embodiment.

FIG. 4B illustrates an example of an FDB held by each SW according to the first embodiment.

FIG. 5A illustrates an example of SW registration information according to the first embodiment.

FIG. 5B illustrates an example of SW registration information according to the first embodiment.

FIG. 6A illustrates, in table format, information acquired from each SW by a location identification processing unit 13 according to the first embodiment, and flag information.

FIG. 6B illustrates, in table format, information acquired from each SW by the location identification processing unit 13 according to the first embodiment, and flag information.

FIG. 6C illustrates, in table format, information acquired from each SW by the location identification processing unit 13 according to the first embodiment, and flag information.

FIG. 6D illustrates, in table format, information acquired from each SW by the location identification processing unit 13 according to the first embodiment, and flag information.

FIG. 6E illustrates, in table format, information acquired from each SW by the location identification processing unit 13 according to the first embodiment, and flag information.

FIG. 7 illustrates an example of the display content of an identified connection location.

FIG. 8A illustrates an example of SW registration information according to the first embodiment.

FIG. 8B illustrates an example of SW registration information according to the first embodiment.

FIG. 9A illustrates, in table format, information acquired from each SW by the location identification processing unit 13 according to the first embodiment, and flag information.

FIG. 9B illustrates, in table format, information acquired from each SW by the location identification processing unit 13 according to the first embodiment, and flag information.

FIG. 9C illustrates, in table format, information acquired from each SW by the location identification processing unit 13 according to the first embodiment, and flag information.

FIG. 9D illustrates, in table format, information acquired from each SW by the location identification processing unit 13 according to the first embodiment, and flag information.

FIG. 9E illustrates, in table format, information acquired from each SW by the location identification processing unit 13 according to the first embodiment, and flag information.

### DESCRIPTION OF EMBODIMENTS

Hereinafter, one embodiment of the present disclosure will be described with reference to the accompanying drawings. Embodiments are examples for explaining the present invention and are omitted and simplified as appropriate for clarity of explanation. The present invention can also be implemented in various other forms. Unless otherwise specified, each component may be singular or plural.

The position, size, shape, range, and the like of each component illustrated in the drawings may not represent the actual position, size, shape, range, and the like in order to facilitate understanding of the present invention. Therefore, the present invention is not necessarily limited to the position, size, shape, range, and the like disclosed in the drawings. In cases where there are a plurality of components having the same or similar functions, the components may be described by adding different subscripts to the same reference numeral. In addition, if it is not necessary to distinguish between the plurality of components, the subscripts may be omitted in the description.

In the embodiments, processing performed by executing a program may be described. Here, a computer executes a program using a processor (for example, a CPU or a GPU), and performs processing defined by the program while using storage resources (for example, memory), interface devices (for example, communication ports), and the like. Therefore, the entity that carries out the processing by executing the program may be a processor. Similarly, the entity that carries out the processing by executing the program may be a controller, device, system, computer, or node having a processor.

The entity that carries out the processing by executing the program needs only to be a calculation unit, and may include a dedicated circuit for specific processing. Here, examples of the dedicated circuit include a Field Programmable Gate Array (FPGA), an Application Specific Integrated Circuit (ASIC), a Complex Programmable Logic Device (CPLD), and the like.

The program may be installed on the computer from a program source. The program source may be, for example, a program distribution server or a computer-readable storage medium. If the program source is a program distribution server, the program distribution server may include a processor and a storage resource that stores a program to be distributed, and the processor of the program distribution server may distribute the program to be distributed to other computers. In addition, in the embodiment, two or more programs may be implemented as one program, or one program may be implemented as two or more programs.

### First Embodiment

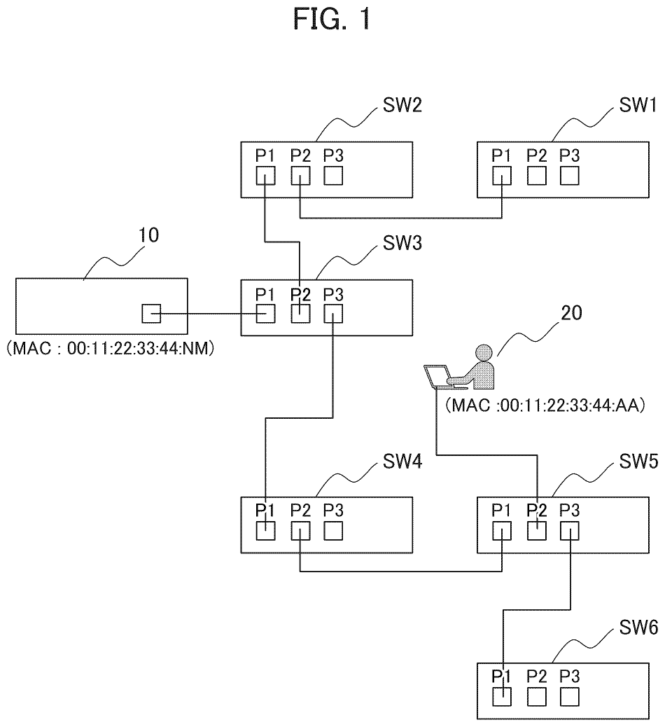

FIG. 1 is a block diagram illustrating an example of the overall configuration of a network according to a first embodiment. Note that in the present embodiment, the network is comprised of a plurality of switching hubs (hereinafter referred to as SW) serving as network devices.

In FIG. 1, the network is comprised of six SWs (SW1 to SW6). Each of the SWs includes a plurality of connection ports (P1 to P3 in FIG. 1) and is connected to other SWs or devices or equipment such as personal computers and printers via Local Area Network (LAN) cables connected to these connection ports. In FIG. 1, SW2 is connected to the connection port P1 of SW1 via the connection port P2 of SW2, SW3 is connected to the connection port P1 of SW2 via the connection port P2 of SW3, SW4 is connected to the connection port P3 of SW3 via the connection port P1 of SW4, SW5 is connected to the connection port P2 of SW4 via the connection port P1 of SW5, and SW6 is connected to the connection port P3 of SW5 via the connection port P1 of SW6. In addition, an apparatus (hereinafter referred to as a location identification apparatus or NM) 10 that identifies the connection location of a device connected to the network is connected to the connection port P1 of SW3.

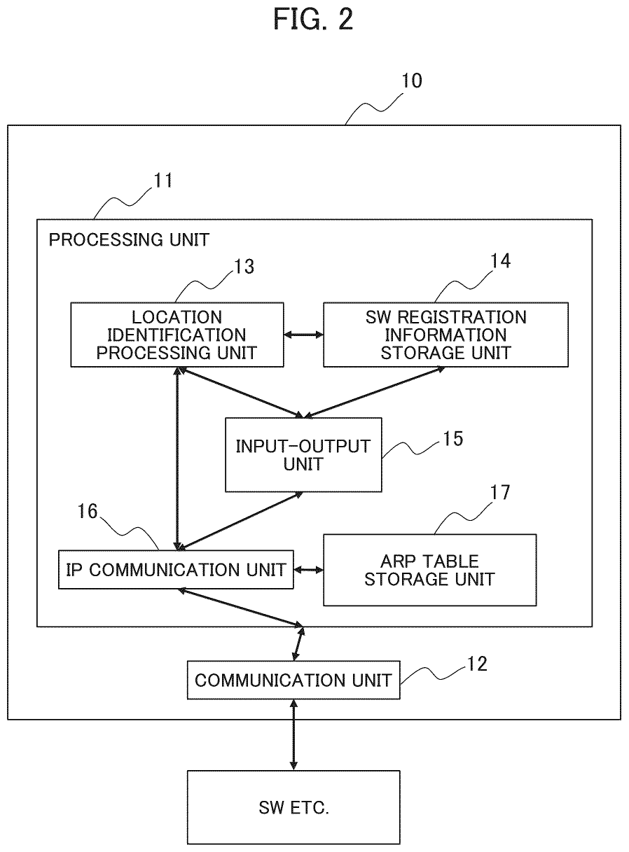

FIG. 2 is a block diagram illustrating an example of the configuration of the location identification apparatus 10. In FIG. 2, the location identification apparatus 10 includes a processing unit 11 and a communication unit 12. The communication unit 12 is an interface that is connected to an external device (SW or the like) and communicates with the external device. The processing unit 11 is comprised of a location identification processing unit 13, an SW registration information storage unit 14, an input-output unit 15, an IP communication unit 16, and an ARP table storage unit 17. The location identification processing unit 13 performs processing for identifying the connection location of a device connected to the network, as described below. The SW registration information storage unit 14 stores and holds information relating to each SW that constitutes the network. The input-output unit 15 is for inputting information to the processing unit 11 from an input-output device, such as a keyboard, connected to the location identification apparatus 10 and for outputting information from the processing unit 11 to a display or the like. The IP communication unit 16 is used to communicate with external devices using Internet Protocol (IP) addresses, and the ARP table storage unit stores information indicating the correspondence between the IP address and MAC address of the communication destination, and is referred to and used by the IP communication unit 16.

In the present embodiment, the location identification apparatus 10 is a simple apparatus with the same level of performance as, for example, an SW, but with lower processing power and smaller memory capacity than a typical personal computer. One implementation example of the location identification apparatus 10 is, for example, a system-on-chip configuration. In this implementation example, the processing unit 11 is a single semiconductor chip, and a central processor and memory are embedded in the semiconductor chip. The location identification processing unit 13, input-output unit 15, and IP communication unit 16 in the processing unit 11, which is a single semiconductor chip, are configured to operate according to a program embedded in the semiconductor chip. In addition, the SW registration information storage unit 14 and the ARP table storage unit 17 are stored in the memory in the semiconductor chip. In this implementation example, for example, the central processor is a single core that operates at a clock speed of about several hundred MHz, and the memory is about 32 MByte.

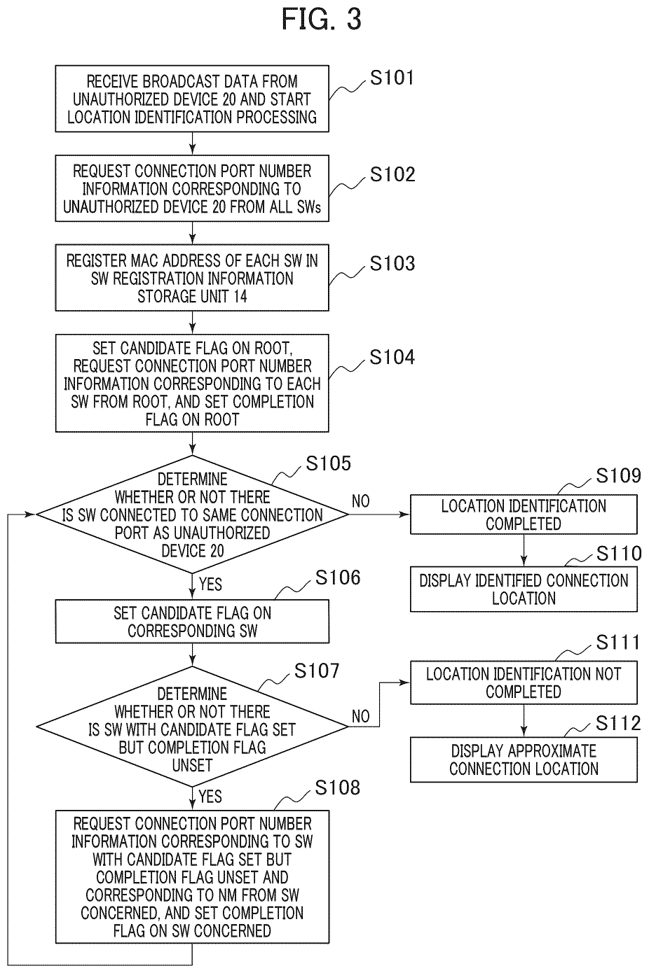

In addition, the processing unit 11 of the location identification apparatus 10 has SNMP manager software pre-installed, while each SW has embedded SNMP agent software, and the location identification processing unit 13 uses the SNMP to identify the connection location of a device connected to the network. FIG. 3 illustrates an example of the procedure of processing for identifying the connection location of an unauthorized device connected to the network (hereinafter referred to as location identification processing) as performed by the location identification processing unit 13. As a prerequisite for the location identification processing, an unauthorized device 20 is connected to the connection port P2 of SW5 in FIG. 1. The unauthorized device 20 is, for example, a privately-owned personal computer that has not been approved for connection by the administrator of the network illustrated in FIG. 1. When connected to SW5, the unauthorized device 20 broadcasts data containing its own MAC address “00:11:22:33:44:AA” to initiate communication. The broadcast data from the unauthorized device 20 is received by each SW and the location identification apparatus 10.

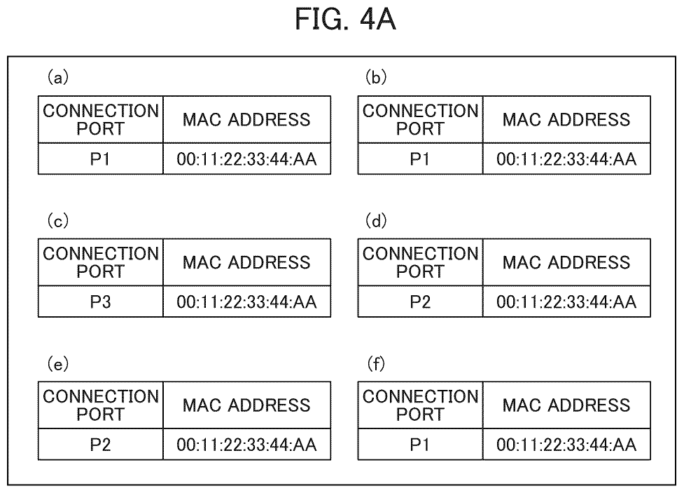

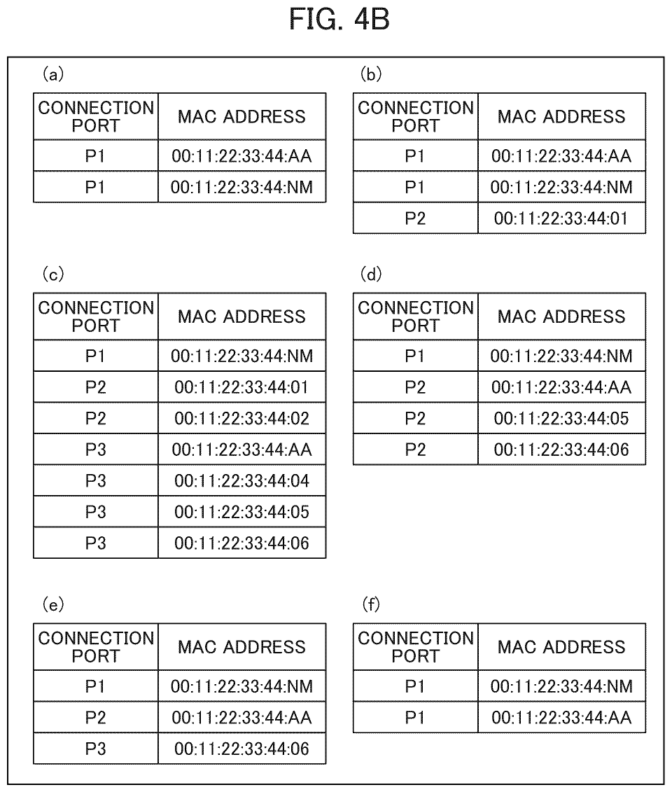

Upon receiving the data, each SW uses an automatic learning function to associate the data reception port number with the MAC address contained in the data and registers the result in the FDB held by each SW. FIG. 4A illustrates an example of the FDB held by each SW, and illustrates the state of the FDB when broadcast data from the unauthorized device 20 is received. In FIG. 4A, (a) to (f) correspond to the FDBs of SW1 to SW6, respectively. For example, since SW5 receives data directly from the unauthorized device 20 connected to the connection port P2, as illustrated in FIG. 4A (e), the connection port P2, which is the data reception port number, and the MAC address of the unauthorized device 20 are registered in the FDB of SW5 in association with each other. In addition, since SW3 receives data via the connection port P3 through SW5 and SW4, as illustrated in FIG. 4A(c), the connection port P3, which is the data reception port number, and the MAC address of the unauthorized device 20 are registered in the FDB of SW3 in association with each other. The same applies to the other SWs. Note that for ease of explanation, FIG. 4A illustrates an example of each FDB when the unauthorized device 20 is connected in a state where no information is registered in each FDB (in the initial stage when the network is configured).

Returning to FIG. 3, the location identification processing will be described. In S101, the location identification apparatus 10 receives broadcast data from the unauthorized device 20 via the communication unit 12. By receiving this data, the location identification processing unit 13 detects that a device has been newly connected to the network. At this time, the location identification processing unit 13 may, for example, hold a group of MAC addresses of devices approved for connection in advance by the administrator, and detect that the new connected device is an unauthorized device by checking the MAC address against the group of MAC addresses. Alternatively, upon detecting a new connected device, the location identification processing unit 13 may display the MAC address of the connected device on a display or the like using the input-output unit 15 illustrated in FIG. 2, and the administrator may determine whether or not the device is an unauthorized device on the basis of the displayed MAC address. The location identification processing unit 13 starts the location identification processing on the basis of the above detection result.

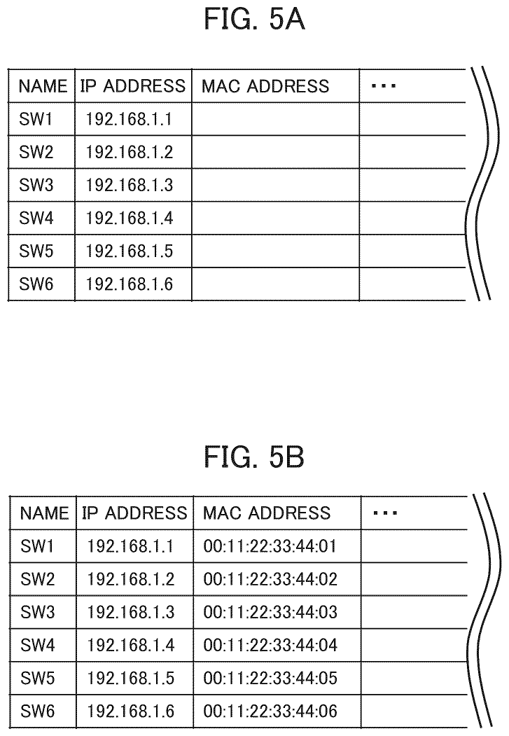

As described above, the processing unit 11 of the location identification apparatus 10 holds, in the SW registration information storage unit 14, information relating to each SW that constitutes the network. FIG. 5A illustrates an example of SW registration information stored in the SW registration information storage unit 14. In FIG. 5A, in the SW registration information, at least the SW name, IP address, and MAC address are registered for each SW in association with each other. Other information, such as community names representing groups of devices to be managed, is also registered as SW registration information. Note that for ease of explanation, FIG. 5A illustrates an example of SW registration information at the time when the location identification processing unit 13 starts location identification processing for the first time. At this time, the name and IP address of each SW are registered, which the SNMP manager in processing unit 11 has previously ascertained as the network configuration using SNMP.

Returning to FIG. 3, in S102, the location identification processing unit 13 uses the IP communication unit 16 to send, to all SWs, a Get Request requesting the connection port number information corresponding to the MAC address “00:11:22:33:44:AA” of the unauthorized device 20 on the basis of the SW registration information illustrated in FIG. 5A.

Each of the SWs receives the Get Request and sends (response) the connection port number corresponding to the MAC address of the unauthorized device 20 to the location identification apparatus 10 using a Get Response. At this time, each SW uses the automatic learning function to associate the reception port number of the Get Request with the MAC address “00:11:22:33:44:NM” of the location identification apparatus 10 and register the result in the FDB, and also associate the reception port numbers when Get Responses from other SWs are received (passed through), with the MAC addresses of the source SWs, and register the results in the FDB.

FIG. 4B, similar to FIG. 4A, illustrates an example of the FDB held by each SW, and illustrates the state of the FDB of each SW with additional information registered as described above as a result of the execution of the processing of S102 by the location identification processing unit 13. In FIG. 4B, (a) to (f) correspond to the FDBs of SW1 to SW6, respectively. For example, SW3 receives a Get Request directly from the location identification apparatus 10 connected to the connection port P1, and also receives Get Responses from all other SWs via the connection port P2 or P3 and sends (relays) the Get Responses to the location identification apparatus 10. Therefore, as illustrated in FIG. 4B(c), the connection port P1, which is the reception port number of the Get Request, is associated with the MAC address of the location identification apparatus 10, and the connection port numbers, which are the reception port numbers of the Get Responses from all other SWs, are associated with the MAC addresses of all other SWs, and the results are additionally registered in the FDB of SW3. In addition, SW5 receives a Get Request via the connection port P1 through SW3 and SW4 and also receives a Get Response from SW6 via the connection port P3. Therefore, as illustrated in FIG. 4B(e), the connection port P1, which is the reception port number of the Get Request, is associated with the MAC address of the location identification apparatus 10, and the connection port P3, which is the reception port of the Get Response from SW6, is associated with the MAC address of SW6, and the results are additionally registered in the FDB of SW5. The same applies to the other SWs.

Note that as described above, FIG. 4A illustrates an example of each FDB when the unauthorized device 20 is connected in a state where no information is registered in each FDB (in the initial stage when the network is configured, or in a state where sufficient time (aging time) has elapsed after communication passes through each SW during network operation). However, once the location identification processing has been completed by the location identification apparatus 10, or immediately after the network operation has started and communication has passed through each SW, the FDB of each SW is in the state illustrated in FIG. 4B or in a state where more information relating to the connected device is registered. Therefore, for each SW where the FDB is in such a state, the location identification processing unit 13 performs the location identification processing.

Returning to FIG. 3, in S103, the location identification processing unit 13 registers the MAC address of each SW in the SW registration information storage unit 14. For example, upon sending a Get Request to each SW using the IP communication unit 16 in S102, the location identification processing unit 13 uses the information stored in the ARP table storage unit 17 to register the MAC address of each SW in the SW registration information storage unit 14. FIG. 5B, similar to FIG. 5A, illustrates an example of the SW registration information stored in the SW registration information storage unit 14, and illustrates the state of SW registration information with the MAC address additionally registered in addition to the name and IP address of each SW as a result of the execution of the processing of S103 by the location identification processing unit 13. Note that once the processing of S103 is executed, the MAC address of each SW is stored in the SW registration information storage unit 14, and therefore the location identification processing unit 13 does not need to repeat S103 in the subsequent location identification processing.

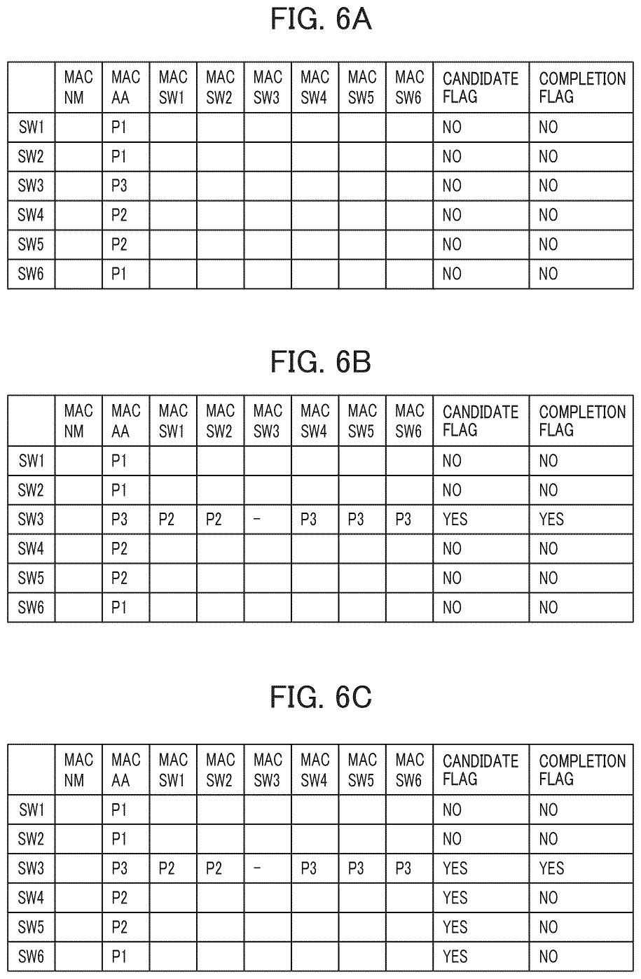

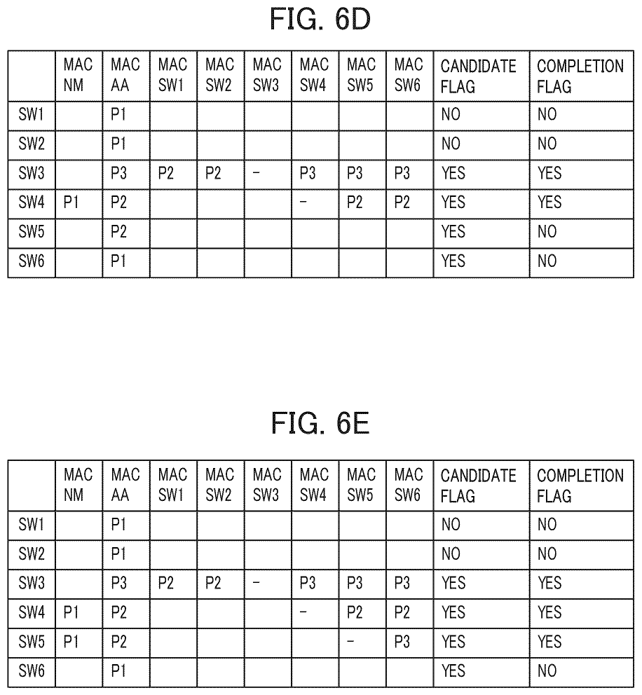

As a result of executing the processing of S102, the location identification processing unit 13 acquires the connection port number corresponding to the MAC address of the unauthorized device 20 from each SW. FIGS. 6A to 6E illustrate, in table format, the information acquired by the location identification processing unit 13 from each or a specific SW as a result of executing the processing from S102 onward, and the flag information required for processing. The location identification processing unit 13 does not necessarily store the acquired information and the flag information required for processing into the memory in such table format, but in FIGS. 6A to 6E, for ease of explanation, the acquired information and the flag information required for processing are illustrated in an organized table format. In the tables illustrated in FIGS. 6A to 6E, the vertical axis indicates the name of each SW, and the horizontal axis indicates the information acquired by the location identification processing unit 13, namely, the connection port numbers corresponding to the MAC addresses of the unauthorized device 20, each SW, and the like, and the “candidate flag” and “completion flag” information required for processing.

First, FIG. 6A illustrates the connection port number corresponding to the MAC address of the unauthorized device 20, acquired by the location identification processing unit 13 from each SW as a result of executing the processing of S102 described above. In FIG. 6A, “MAC AA” in the third column and first line of the table indicates the MAC address of the unauthorized device 20, and the second and subsequent lines show the connection port number of each SW corresponding to that MAC address. These connection port numbers correspond to the information in the FDB of each SW illustrated in FIGS. 4A and 4B.

Returning to FIG. 3, in S104, the location identification processing unit 13 sets SW3, to which the location identification apparatus 10 is connected, as the root and sets the candidate flag on SW3, which serves as the root (in FIG. 6A, the candidate flag corresponding to SW3 in the fourth row of the table is changed from No to Yes). Next, the location identification processing unit 13 requests the connection port number information corresponding to the MAC address of each SW from the root in the same manner as in S102. Since the FDB held by SW3, which serves as the root, is in the state illustrated in FIG. 4B(c), SW3 responds to this request by sending, to the location identification apparatus 10, the connection port numbers corresponding to the MAC addresses of all other SWs.

FIG. 6B illustrates connection port numbers corresponding to the MAC addresses of the SWs other than the root, acquired by the location identification processing unit 13 from the root as a result of executing the processing of S104. “MAC SW1” to “MAC SW6” from the fourth column onward in the first row of the table indicate the MAC addresses of the SWs, and the fourth row (the row relating to SW3) shows the connection port numbers corresponding to those MAC addresses. In S104, upon completing the acquisition of the connection port number information from the root, the location identification processing unit 13 sets the completion flag (changes the completion flag corresponding to SW3 in the fourth row of the table in FIG. 6B from No to Yes).

In S105, the location identification processing unit 13 determines whether or not there is a connection port number that is the same as the connection port number corresponding to the MAC address of the unauthorized device 20, among the connection port numbers corresponding to the MAC addresses of the SWs acquired from the root. In FIG. 6B, the connection port number of SW3 corresponding to the MAC address “MAC AA” of the unauthorized device 20 is P3, which means that in SW3, the unauthorized device 20 is connected to the connection port P3. Therefore, the location identification processing unit 13 determines that there are SW4 to SW6, the connection port number corresponding to the MAC address of which is P3, that is, SW4 to SW6 are connected to the same connection port P3 as the unauthorized device 20 in SW3. Based on the above-mentioned determination result in S105, the location identification processing unit 13 proceeds to the processing of S106.

In S106, candidate flags of SW4 to SW6 determined in S105 to be connected to the same connection port P3 as the unauthorized device 20 are set. FIG. 6C illustrates the state after the location identification processing unit 13 executes the processing of S106, and by setting the candidate flags on SW4 to SW6, the candidate flags corresponding to SW4 to SW6 in the fifth to seventh rows of the table have been changed from No to Yes.

In S107, the location identification processing unit 13 determines whether or not there is an SW with the candidate flag set but the completion flag unset. In FIG. 6C, there are three SW4 to SW6 that match the conditions (the candidate flag is Yes and the completion flag is No), and therefore the location identification processing unit 13 determines that there are SW4 to SW6, and proceeds to the processing of S108.

In S108, the location identification processing unit 13 requests the connection port number information corresponding to the MAC addresses of all SWs with the candidate flags set and the MAC address of the location identification apparatus 10 to one of the SWs determined to match the conditions in S107. As described above, in FIG. 6C, the SWs that match the conditions are SW4 to SW6. In addition, in FIG. 6C, the candidate flags for SW3 to SW6 are set to Yes. Therefore, the location identification processing unit 13 requests the connection port number information corresponding to the MAC addresses of SW3 to SW6 and the MAC address of the location identification apparatus 10 from SW4 among the SWs that match the conditions. Since the FDB held by SW4 is in the state illustrated in FIG. 4B (d), SW4 responds to this request by sending, to the location identification apparatus 10, the connection port numbers corresponding to the MAC addresses of SW5, SW6, and the location identification apparatus 10.

FIG. 6D illustrates the connection port numbers corresponding to the MAC addresses of SW5, SW6, and the location identification apparatus 10, acquired by the location identification processing unit 13 from SW4 as a result of executing the processing of S108. The fifth row (row relating to SW4) of the table shows those connection port numbers. In S108, upon completing the acquisition of the connection port number information from SW4, the location identification processing unit 13 sets the completion flag (changes the completion flag corresponding to SW4 in the fifth row of the table in FIG. 6D from No to Yes).

When the processing of S108 is completed, the location identification processing unit 13 repeats the processing from S105 onward again. In FIG. 6D, the connection port P2 corresponding to the MAC addresses of SW5 and SW6 among the connection port numbers acquired from SW4 is the same as the connection port P2 corresponding to the MAC address of the unauthorized device 20. Therefore, in S105, the location identification processing unit 13 determines that SW5 and SW6 are connected to the connection port P2 of SW4 as well as the unauthorized device 20.

In S106, since the candidate flags have already been set on SW5 and SW6, the processing proceeds to S107. In S107, since SW5 and SW6 match the conditions as illustrated in FIG. 6D, the location identification processing unit 13 determines that there are SW5 and SW6. In S108, SW5 among the SWs that match the conditions in S107 is requested to provide the connection port number information corresponding to the MAC address of SW6 with the candidate flag set but the completion flag unset, and the MAC address of the location identification apparatus 10. Since the FDB held by SW5 is in the state illustrated in FIG. 4B (e), SW5 responds to this request by sending, to the location identification apparatus 10, the connection port numbers corresponding to the MAC addresses of SW6 and the location identification apparatus 10.

FIG. 6E illustrates the connection port numbers corresponding to the MAC addresses of SW6 and the location identification apparatus 10, acquired by the location identification processing unit 13 from SW5 as a result of executing the processing of S108. The sixth row (row relating to SW5) of the table shows those connection port numbers. In S108, upon completing the acquisition of the connection port number information from SW5, the location identification processing unit 13 sets the completion flag (changes the completion flag corresponding to SW5 in the sixth row of the table in FIG. 6E from No to Yes).

Upon completing the processing of S108, the location identification processing unit 13 executes the processing of S105 again, but in FIG. 6E, there is no connection port number that is the same as the connection port P2 corresponding to the MAC address of the unauthorized device 20 among the connection port numbers acquired from SW5. Therefore, the location identification processing unit 13 determines that there is no corresponding SW. This determination result identifies that the unauthorized device 20 is connected to the connection port P2 of SW5, and the location identification processing unit 13 completes the location identification processing in S109. Then, in S110, the location identification processing unit 13 displays the connection location of the unauthorized device 20 in the network as identified by the location identification processing, that is, that the unauthorized device 20 is connected to the connection port P2 of SW5, on a display or the like using the input-output unit 15.

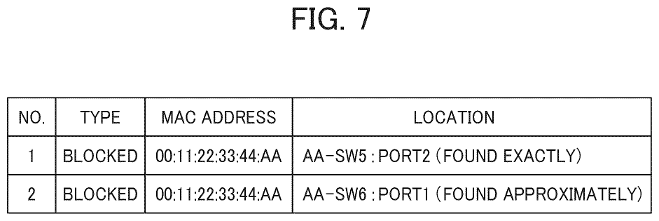

FIG. 7 illustrates an example of the display content of an identified connection location. In FIG. 7, the “Type” column indicates whether or not the device has been approved for connection by the administrator. For example, “Permitted” is displayed for an approved device, and “Blocked” is displayed for an unapproved device. The “MAC Address” column displays the MAC Address of the connected device. The “Location” column displays the identified connection location. For example, the result of the location identification processing according to the first embodiment is shown in row No. 1 in FIG. 7, where the “Location” column indicating the identified connection location indicates that the unauthorized device 20 is connected to the connection port P2 of SW5. Specifically, the first “AA” is a symbol indicating the unauthorized device 20, the next “-SW5” indicates SW5 to which the unauthorized device 20 is connected, the next “:Port2” indicates the connection port number P2 to which the unauthorized device 20 is connected, and the last “(Found Exactly)” indicates that the location identification processing is completed and the location has been identified. This display allows the administrator to ascertain the connection location of the unauthorized device 20.

As described above, in the location identification processing performed by the location identification apparatus according to the first embodiment, it is possible to identify the connection location of an unauthorized device connected to the network without acquiring all the information in the FDB from each network device that constitutes the network. Thus, even if a simple apparatus with lower processing power and smaller memory capacity than a typical personal computer is used as a location identification apparatus, it is possible to identify the connection location of an unauthorized device, and by not acquiring all the information from the FDB of each network device, the time required to identify the connection location is reduced, thereby making it possible to efficiently identify the connection location of the unauthorized device.

### Second Embodiment

In the first embodiment, an example has been described in which SNMP agent software is embedded in each SW that constitutes the network and all of the SWs can respond to various requests using SNMP from the location identification apparatus 10. However, there may also be a case where part of the network includes an SW (hereinafter referred to as a non-intelligent SW) that does not have embedded SNMP agent software and does not respond to requests from the SNMP manager. In the second embodiment, an example will be described in which part of the network includes such a non-intelligent SW, and furthermore, the location identification apparatus 10 executes location identification processing for an unauthorized device connected to the non-intelligent SW.

The network configuration according to the second embodiment shall be the same as that illustrated in FIG. 1. However, in the second embodiment, SW5 in FIG. 1 is assumed to be the above non-intelligent SW. Note that naturally, the non-intelligent SW holds the FDB and relays data and the like in the same manner as the other SWs, except that the non-intelligent SW does not respond to requests from the SNMP manager. In addition, the configuration of the location identification apparatus 10 and the procedure for the location identification processing according to the second embodiment shall be the same as those illustrated in FIGS. 2 and 3. In the following description, for such same configurations and the like as those in the first embodiment, a description of the duplicate content will be omitted, and only the differences will be described.

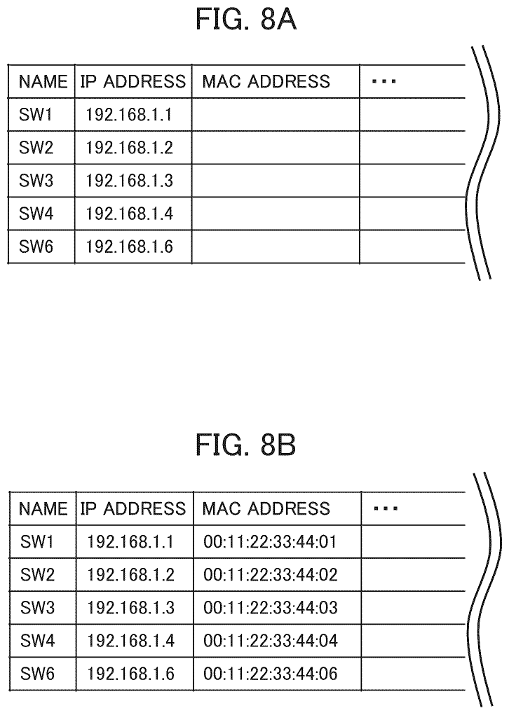

First, as in the first embodiment, the unauthorized device 20 is connected to the connection port P2 of SW5 and broadcasts data containing its own MAC address “00:11:22:33:44:AA”. The subsequent automatic learning of the FDB regarding the unauthorized device 20 by each SW and detection of the connected device by the location identification apparatus 10 in S101 are the same as in the first embodiment. In addition, as in the first embodiment, the processing unit 11 holds, by means of the SW registration information storage unit 14, information relating to the SWs that constitute the network, but the contents are different from those illustrated in FIGS. 5A and 5B. FIGS. 8A and 8B illustrate an example of SW registration information stored in the SW registration information storage unit 14 according to the second embodiment. The items of registration information are similar to those in FIGS. 5A and 5B, but in FIGS. 8A and 8B, information relating to SW5, which is the non-intelligent SW, is not registered. This is because the SNMP manager in the processing unit 11 cannot ascertain the existence or information of SW5. Note that as in FIG. 5A, FIG. 8A illustrates an example of SW registration information at the time when the location identification processing unit 13 starts location identification processing for the first time, and FIG. 8B illustrates an example of SW registration information after the execution of the processing of S103 by the location identification processing unit 13.

In S102 in FIG. 3, the location identification processing unit 13 requests the connection port number information corresponding to the MAC address “00:11:22:33:44:AA” of the unauthorized device 20 from SW1 to SW4 and SW6 on the basis of the SW registration information illustrated in FIG. 8A. Upon receiving this request, each SW responds with the connection port number corresponding to the MAC address of the unauthorized device 20. Note that the automatic learning of the FDB by each SW in this case is also similar to the first embodiment, and thus the contents of the FDB held by each SW are the same as those illustrated in FIGS. 4A and 4B.

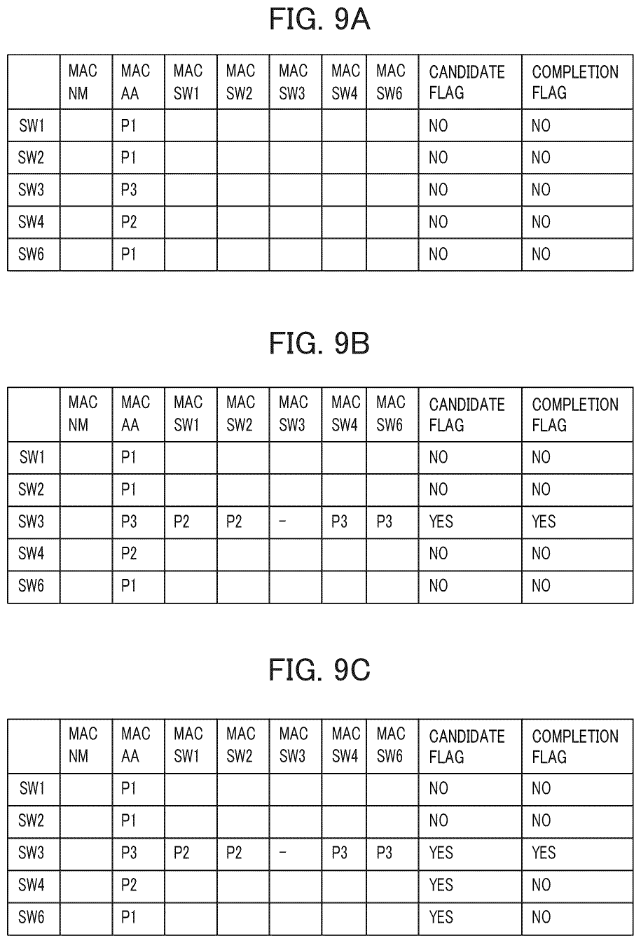

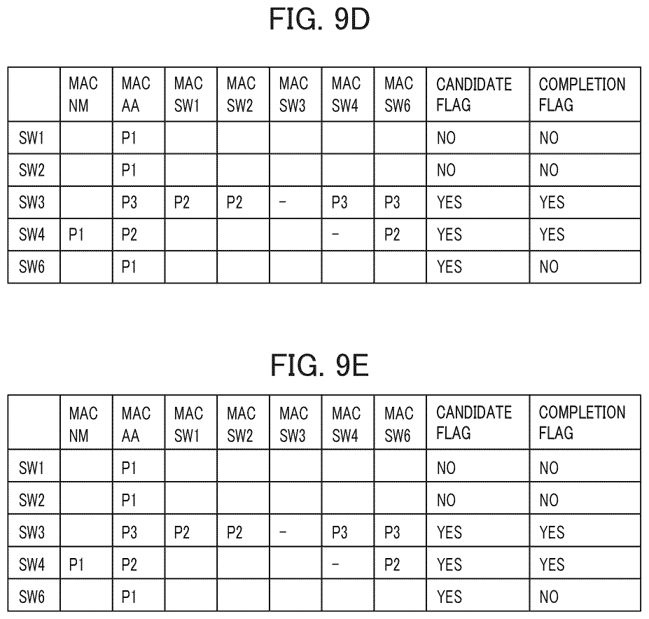

FIGS. 9A to 9E illustrate, in table format, the information acquired by the location identification processing unit 13 from each or a specific SW as a result of executing the processing from S102 onward, similar to FIGS. 6A to 6E in the first embodiment. FIG. 9A illustrates the connection port numbers corresponding to the MAC address of the unauthorized device 20, acquired by the location identification processing unit 13 from each SW as a result of executing the processing of S102 above, which is approximately the same as the content of FIG. 6A, but the information relating to SW5 to which the location identification processing unit 13 has not sent a request as described above is not shown in this table. In this manner, except that the location identification processing unit 13 does not ascertain SW5 and does not make any request or acquire any information, the processing contents from S102 onward and the information acquired by the location identification processing unit 13 through the processing execution are the same.

The location identification processing unit 13 performs S103 to S108 in FIG. 3, as in the first embodiment. As a result of executing the processing up to S108, the information acquired by the location identification processing unit 13 and the flag information are in the state illustrated in FIG. 9D. Then the location identification processing unit 13 repeats the processing from S105 onward again. In the first embodiment, the location identification processing unit 13 executes processing for SW5 and SW6 in S105 to S108 from the second time onward, but in the second embodiment, processing is executed only for SW6. As a result of repeating the processing from S105 to S108 in this manner, the information acquired by the location identification processing unit 13 and the flag information are in the state illustrated in FIG. 9E. Then the location identification processing unit 13 executes the processing from S105 onward again, but in the third S107, as illustrated in FIG. 9E, there are no more SWs with the candidate flag set but the completion flag unset, so that the location identification processing unit 13 determines that there is no corresponding SW.

As the result of this determination, the connection location of the unauthorized device 20 has not been identified, and in S111, the location identification processing unit 13 terminates the location identification processing with the location identification incomplete. Then, in S112, the location identification processing unit 13 displays the connection port P1 of the SW6 from which information is acquired last, as the approximate connection location of the unauthorized device 20, on a display or the like using the input-output unit 15. The result of the location identification processing according to the second embodiment is shown in row No. 2 in FIG. 7, where the “Location” column displays “AA” indicating the unauthorized device 20, “-SW6” indicating SW6 to which the unauthorized device 20 is assumed to be connected, “:Port1” indicating the connection port P1 to which the unauthorized device 20 is assumed to be connected, and finally “(Found Approximately)” indicating that this is the approximate connection location. This indication allows the administrator to ascertain that the location identification has not been completed and the approximate connection location of the unauthorized device 20.

Note that in the second embodiment, the case where the device is connected to the non-intelligent SW has been described, but there may also be a case where the non-intelligent SW exists between the location identification apparatus 10 and the SW to which the device is connected. In this case, the location identification apparatus 10 cannot ascertain the presence of the non-intelligent SW therebetween, but can receive the response from the SW to which the device is connected. Therefore, it is possible to identify the connection location of the device by executing location identification processing similar to that in the first embodiment.

As explained above, in the location identification processing according to the second embodiment, in addition to the similar effect to that in the first embodiment, even if an unauthorized device is connected to a non-intelligent SW, the approximate connection location of the unauthorized device can be identified and presented to the administrator while the location identification is not complete.

### Third Embodiment

In SNMP, in addition to Get Request, GetNext Request, and the like, by which the SNMP manager requests information from the SNMP agent, a mechanism (command) called SNMP Trap in which the SNMP agent spontaneously notifies the SNMP manager is defined. The SNMP agent is preconfigured to send SNMP Traps in what cases and for what content. One of the settings can be done so that the SNMP agent in the network device sends an SNMP Trap when a new device is connected to the network device. The third embodiment describes an example in which the location identification apparatus 10 uses such SNMP Trap notification of new device connections to execute the location identification processing.

Note that in the third embodiment, the network configuration, the configuration of the location identification apparatus 10, the location identification processing procedure, the contents of the FDB held by each SW, and the contents of the SW registration information stored in the SW registration information storage unit 14 are all the same as those illustrated in FIGS. 1 to 5B in the first embodiment. However, SW1 to SW6 shall be preconfigured to send an SNMP Trap when a new device is connected.

In the following description, for such same configurations and the like as those in the first embodiment, a description of the duplicate content will be omitted, and only the differences will be described. First, as in the first embodiment, when the unauthorized device 20 is connected to the connection port P2 of SW5, SW5 notifies the location identification apparatus 10 using an SNMP Trap that a new device has been connected. The location identification processing unit 13 receives the SNMP Trap and stores in memory the receipt of a notification of a new device connection from SW5. The subsequent contents from the broadcast of the MAC address from the unauthorized device 20 to the execution of the processing of S103 by the location identification processing unit 13 are the same as in the first embodiment.

In the first embodiment, in the subsequent S104, the location identification processing unit 13 sets SW3, to which the location identification apparatus 10 is connected, as the root, and requests the connection port number information corresponding to the MAC address of each SW from the root. However, in the third embodiment, the location identification processing unit 13 memorizes the receipt of a notification of a new device connection from SW5, as described above and sets SW5, which has sent the notification, as the root. Then the location identification processing unit 13 sets the candidate flag on SW5, which is the root, and requests the connection port number information corresponding to the MAC address of each SW from SW5. Since the FDB held by SW5, which serves as the root, is in the state illustrated in FIG. 4B(e), SW5 responds to this request by sending, to the location identification apparatus 10, the connection port number corresponding to the MAC address of SW6. Upon receiving this response and completing the acquisition of the connection port number information from the root, the location identification processing unit 13 sets the completion flag on SW5.

In the next S105, the location identification processing unit 13 determines whether or not there is a connection port number that is the same as the connection port number corresponding to the MAC address of the unauthorized device 20 among the connection port numbers corresponding to the MAC addresses of the SWs acquired from the root. However, since only the information acquired from SW5 is the connection port P3 corresponding to the MAC address of SW6, while the connection port number corresponding to the MAC address of the unauthorized device 20 is P2, it is determined that there is no corresponding SW. This determination result identifies that the unauthorized device 20 is connected to the connection port P2 of SW5. The subsequent processing in S109 and S110 is similar to that in the first embodiment.

Note that in the third embodiment, a case has been described in which only SW5 notifies using an SNMP Trap that a new device has been connected, and the location identification processing unit 13 sets SW5 as the root. However, there may also be a case where a plurality of devices are connected to different SWs. For example, if two devices are connected, one to SW4 and the other to SW5, SW4 and SW5 each notify using an SNMP Trap that a new device has been connected. In this case, in the process of the location identification processing, the location identification processing unit 13 may, for example, set, as the root, the SW that sent the last received notification before the start of the location identification processing. That is, if the transmission order of SNMP Trap is SW4 and SW5, SW5 shall be the root, and if the order is SW5 and SW4, SW4 shall be the root.

As explained above, in the location identification processing according to the third embodiment, in addition to the similar effect to that in the first embodiment, it is possible to further improve the efficiency of the location identification processing and shorten the identification time by starting the information acquisition from the SW to which the unauthorized device, the location of which is to be identified, is most likely connected.

### Fourth Embodiment

The information registered in the FDB held by each SW is deleted if no data is sent or received from the network devices or equipment with the MAC address contained in the information before the aging time elapses. Therefore, in a case where a location identification apparatus executes location identification processing in a large-scale network, there is a possibility that during the processing, the information requested by the location identification apparatus is deleted from the FDB of the SW to which the request is made, and the information necessary for location identification will no longer be available. In the fourth embodiment, an example of the location identification processing in such a case will be described.

Note that in the fourth embodiment, the network configuration, the configuration of the location identification apparatus 10, the location identification processing procedure, the contents of the FDB held by each SW, and the contents of the SW registration information stored in the SW registration information storage unit 14 are all the same as those illustrated in FIGS. 1 to 5B in the first embodiment. In the following description, for such same configurations and the like as those in the first embodiment, a description of the duplicate content will be omitted, and only the differences will be described.

First, as in the first embodiment, the unauthorized device 20 is connected to the connection port P2 of SW5. The subsequent contents from the broadcast of the MAC address from the unauthorized device 20 to the execution of the processing of S107 by the location identification processing unit 13 are the same as in the first embodiment. As in the first embodiment, in the next S108, the location identification processing unit 13 requests, from SW4, the connection port number information corresponding to the MAC addresses of SW3 to SW6 with the candidate flags set and the MAC address of the location identification apparatus 10. However suppose that at this point, the aging time for the information of SW5 and SW6 in the FDB of SW4 illustrated in FIG. 4B (d) has elapsed and the information has been deleted. In that case, the location identification processing unit 13 cannot acquire the information requested from SW4, that is, the connection port number information relating to SW3 to SW6 with the candidate flag set. As a result, the location identification processing unit 13 determines that the requested information has not been acquired, and proceeds to the processing of S111 as in the second embodiment, and displays the connection port P2 of SW4 from which information is requested last with the location identification incomplete, as the approximate connection location of the unauthorized device 20, on a display or the like using the input-output unit 15.

In the above example, when no information is acquired from SW4, the location identification processing unit 13 terminates the processing with the location identification incomplete. Meanwhile, it is empirically known that the above aging time differs for each piece of information registered in each FDB, and that the timing at which information is deleted may also differ depending on the SW. Therefore, the location identification processing unit 13 may not terminate the processing at the stage where no information is acquired from SW4, but may continue the processing for SW5 and SW6 other than SW4, determined to match the conditions in S107. In this case, after determining that the requested information has not been acquired from SW4, the location identification processing unit 13 subsequently executes the processing of S108 for SW5, for example. If a response containing the information shown in the sixth row of the table in FIG. 6E is acquired from SW5, the location identification processing unit 13 can execute the processing of S105 in the same manner as in the first embodiment to complete location identification. Meanwhile, if it is determined that the requested information has not been acquired even from SW5, the processing of S108 is further subsequently executed for SW6. If a response is acquired from SW6, after repeating the processing of S105 to S107 in the same manner as in the second embodiment, and in S111, the location identification processing unit 13 terminates the location identification processing with the location identification incomplete, and displays the connection port P1 of SW6 as the approximate connection location of the unauthorized device 20, on a display or the like using the input-output unit 15. Meanwhile, upon determining that the requested information has not been acquired even from SW6, in the same manner as in the above example, the location identification processing unit 13 displays the connection port P1 of SW6 from which information is requested last with the location identification incomplete, as the approximate connection location of the unauthorized device 20, on a display or the like using the input-output unit 15.

As explained above, in the location identification processing according to the fourth embodiment, in addition to the similar effect to that in the first embodiment, even if the information in the FDB of the SW to be requested is deleted due to the elapse of aging time, the approximate connection location of the unauthorized device can be identified and presented to the administrator while the location identification is not complete.

Although the embodiments and modifications according to the present invention have been described above, the present invention is not limited to one of the above-described embodiments, but includes various modifications. For example, the above-described embodiments have been described in detail in order to facilitate the understanding of the present invention, and the present invention is not limited to those including all the configurations described here. In addition, part of the configuration of one example of an embodiment can be replaced with the configuration of another example. Further, the configuration of one example of an embodiment can also be added with the configuration of another example. In addition, part of the configuration of one example of each embodiment may be added to, deleted from, or replaced with other configurations. In addition, each of the above-mentioned configurations, functions, processing units, processing means, and the like may be implemented in hardware, for example, by designing some or all of them in an integrated circuit. In addition, the control and information lines in the drawings are those that are considered necessary for illustrative purposes and not all of them are shown. Almost all configurations may be considered to be interconnected.

### LIST OF REFERENCE SIGNS

10 location identification apparatus
11 processing unit
12 communication unit
13 location identification processing unit
14 SW registration information storage unit
15 input-output unit
16 IP communication unit
17 ARP table storage unit
20 unauthorized device

1. A location identification apparatus for an unauthorized device connected to a network that is configured by a plurality of network devices being connected in multiple stages, the location identification apparatus comprising:
a location identification processing unit, wherein
upon receiving a notification of a physical address of the unauthorized device sent from the unauthorized device, the location identification processing unit acquires, from each of the network devices, number of a first connection port corresponding to the physical address of the unauthorized device, among one or more connection ports of each of the network devices,
acquires, from a first network device that is one of the plurality of network devices, number of a second connection port corresponding to a physical address of each of one or more other network devices connected to the first network device, and
identifies a connection location of the unauthorized device by repeating first processing for identifying the one or more other network devices having the second connection port number that is the same as the first connection port number, and second processing for acquiring, from a second network device that is one of the one or more other network devices identified by the first processing, number of a third connection port corresponding to a physical address of each of one or more other network devices connected to the second network device.

2. The location identification apparatus according to claim 1, wherein
a candidate flag for indicating a candidate for the second processing is set on the one or more other network devices identified by the first processing, and a completion flag is set on the second network device that has completed the second processing among the one or more other network devices with the candidate flag set.

3. The location identification apparatus according to claim 2, wherein
the second processing is performed by using one of the one or more other network devices with the candidate flag set but the completion flag unset, as the second network device.

4. The location identification apparatus according to claim 2, wherein
if there is no other network device having the second connection port number that is the same as the first connection port number in the first processing, location identification is completed.

5. The location identification apparatus according to claim 3, wherein
if there is no other network device with the candidate flag set but the completion flag unset, processing is terminated with location identification incomplete, without performing the second processing.

6. The location identification apparatus according to claim 4, wherein
upon the completion of the location identification, the identified connection location of the unauthorized device is output.

7. The location identification apparatus according to claim 5, wherein
when the processing is terminated with the location identification incomplete, the connection port number of the second network device in the last second processing, corresponding to the physical address of the unauthorized device, is output as an approximate connection location of the unauthorized device.

8. A location identification method for an unauthorized device connected to a network that is configured by a plurality of network devices being connected in multiple stages, the method comprising:
upon receiving a notification of a physical address of the unauthorized device sent from the unauthorized device, acquiring, from each of the network devices, number of a first connection port corresponding to the physical address of the unauthorized device among one or more connection ports of each of the network devices;
acquiring, from a first network device that is one of the plurality of network devices, number of a second connection port corresponding to a physical address of each of one or more other network devices connected to the first network device;
executing first processing for identifying the one or more other network devices having the second connection port number that is the same as the first connection port number;
executing second processing for acquiring, from a second network device that is one of the one or more other network devices identified by the first processing, number of a third connection port corresponding to a physical address of each of one or more other network devices connected to the second network device; and
identifying a connection location of the unauthorized device by repeating the first processing and the second processing.

9. The location identification method according to claim 8, wherein
a candidate flag for indicating a candidate for the second processing is set on the one or more other network devices identified by the first processing, and
a completion flag is set on the second network device that has completed the second processing among the one or more other network devices with the candidate flag set.

10. The location identification method according to claim 9, wherein
the second processing is performed by using one of the one or more other network devices with the candidate flag set but the completion flag unset, as the second network device.

11. The location identification method according to claim 9, wherein
if there is no other network device having the second connection port number that is the same as the first connection port number in the first processing, location identification is completed.

12. The location identification method according to claim 10, wherein
if there is no other network device with the candidate flag set but the completion flag unset, processing is terminated with location identification incomplete, without performing the second processing.

13. The location identification method according to claim 11, wherein
upon the completion of the location identification, the identified connection location of the unauthorized device is output.

14. The location identification method according to claim 12, wherein
when the processing is terminated with the location identification incomplete, the connection port number of the second network device in the last second processing, corresponding to the physical address of the unauthorized device, is output as an approximate connection location of the unauthorized device.
